(19) United States
(12) Patent Application Publication
(10) Pub. No.: US 2012/0013232 A1
(43) Pub. Date: Jan. 19, 2012

(54) Miniature Coffin With Spring Loaded Hinge

(76) Inventor: John F. Immen, Arlington Hts., IL (US)

(21) Appl. No.: 13/185,416

(22) Filed: Jul. 18, 2011

Related U.S. Application Data
(60) Provisional application No. 61/364,865, filed on Jul. 16, 2010.

(51) Int. Cl. G10H 5/00

(52) U.S. Cl. 312/319.2

(57) ABSTRACT

A miniature coffin having a small lid and an elongated lid located on the top of the coffin, a spring loaded hinge attached to the small lid to urge the small lid to open, a touch latch attached to the small lid to keep the small lid closed until touched by a person, a recorder located within the coffin, and a switch coupled to the small lid and to the recorder to cause the recorder to play at least one prerecorded message when the small lid is opened.

### REFERENCE TO RELATED APPLICATIONS

This patent application claims the benefit of U.S. Provisional Application No. 61/364,865 filed on Jul. 16, 2010, the disclosure of which is incorporated herein by reference in its entirety.

### BACKGROUND OF THE INVENTION

1. Field of the Invention

The present invention relates generally to a novelty music box and more specifically to a miniature coffin having a sound card that has recorded thereon at least one recorded voice message which can be overridden with a personalized message.

2. Description of Related Art

Novelty items such as boxes for holding or displaying jewelry, toy items etc., and which may include music is known in the prior art. More specifically, by way of example, U.S. Pat. No. 7,765,655 to Dannenberg discloses providing an electronic audio communication system for placement in a casket to automatically electronically generate post-burial communications in said casket. The burial casket is thus adapted with an audio message system containing electronically stored audio and music files that are automatically played in accordance with a programmed schedule thereby allowing surviving members means for communicating to the deceased for a period of time after burial. A timing mechanism maintains track of the date, day, and time, to allow for the selective broadcast of audio content automatically in accordance with user programmed and selected scheduling. A battery power source provides electrical power for the system.

U.S. Pat. No. 7,251,957 to Solomon discloses a musical jewelry apparatus having a front member, a rear member, a hinge member, a musical and a power source. The hinge member is partially disposed on a portion of the front member and a portion of the rear member; and is adapted to hingedly connect the front member and the rear member. The musical member, which is powered by the power source, is disposed in either the front member or the rear member.

U.S. Pat. No. 6,538,186 to Huang discloses a music box having a cover unit, a sound-emitting device, a transmission mechanism and a moving picture wherein the transmission mechanism is installed in the box unit and the cover unit and the components include a plurality of moving objects that swing leftward, rightward, upward, and downward.

U.S. Pat. No. 5,944,254 to Liu discloses a savings coin box with a controllable music box which includes a body, a music box, a control device and other elements.

U.S. Pat. No. 5,696,333 to Shih discloses a music jewelry cabinet having a space left behind a top drawer for mounting a music-producing means. A spring winding shaft projects from the music-producing for winding a spring of the music-producing means. When the spring winding shaft is released, it rotates the cylinder to produce music and to rotate an ornament.

U.S. Pat. No. 5,329,433 to Geeting, et al. discloses a jewelry box which incorporates a light source to direct light rays at the jewelry contained therein when the jewelry box is opened. A miniature, high-intensity lamp bulb is mounted at the inner surface of the top section, a power source is contained under the jewelry support pad located in the bottom section, and electric switch is incorporated into the hinge about which the top section pivots relative to the bottom section. The switch automatically closes the electrical circuit between the power source and the light source when the box is opened.

U.S. Pat. No. 5,231,266 to Warren discloses a towelette warmer for warming and dispensing premoistened, prepackaged disposable towelettes. The towelette warmer has a body that contains a watertight vessel and a temperature controlled electric heater. A first lid hinged to the vessel has an aperture through which towelettes are dispensed one at a time. A second lid hinged to the first lid closes the aperture when it is not in use. Other features that may be incorporated into the towelette warmer include a music box.

U.S. Pat. No. 4,934,980 to Egolf, et al. discloses a novelty music box where a deer-like configuration is provided with a deer-like head outline and includes a mechanical sound-generating music box and a bulb which is intermittently actuated.

U.S. Pat. No. 4,575,347 to Kitamura discloses a toy music box having eyes which are oscillated back and forth for where the distance between the eyes can be varied to make the device usable with different casings.

U.S. Pat. No. 4,193,648 to Gargiulo discloses a music box casing structure which permits ease and convenience of assembly.

U.S. Pat. No. 4,050,342 to Suzuki, et al. discloses a music box contained within the toy, a movable appendage partially projecting externally of the toy, means for driving the appendage, and a connecting member for operationally connecting the appendage with the drive means. During playing time of the music box, the appendage is moved by the drive means.

### SUMMARY OF THE INVENTION

In an exemplary embodiment of the present invention, there is disclosed a miniature coffin having a small lid and an elongated lid. When the small lid is opened, a sensor operates a recorder located in the bottom of the coffin to start playing one of at least four messages A reset button located on the coffin allows a user to over-ride the recorded message(s) and personalize the message with his/her own message. The recording equipment including a recorder, a microphone, a replaceable battery, and a speaker which can be located in the coffin.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals, where

FIG. 1 is a side perspective view of a miniature coffin in accordance with the principles of the invention; and

FIG. 2 is a plan view of the bottom of the coffin of FIG. 1.

### DESCRIPTION OF THE PREFERRED EMBODIMENT

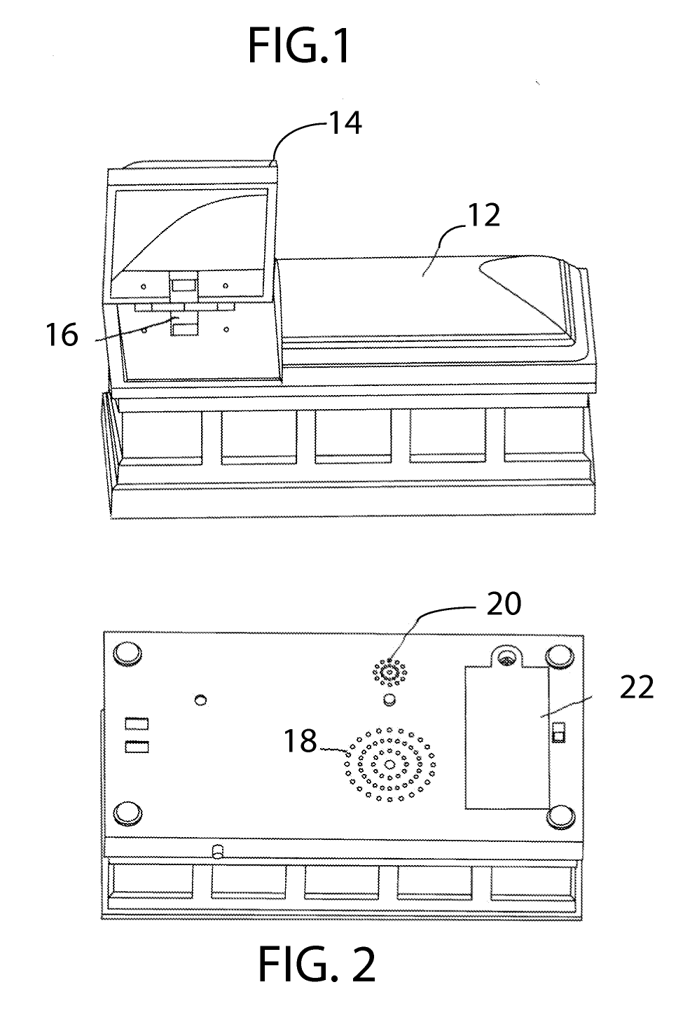

Referring to FIG. 1, there is disclosed a side perspective view of the miniature coffin in accordance with the principles of the invention. The miniature coffin 10 can be made of a plastic, fiberglass, wood, metal, etc., having a desired size such as, by way of example only, five to nine inches in length, two to three inches in width, and one to two inches in height.

The outside surface of the coffin is configured to look like a real coffin and can have a high luster wood finish such as mahogany, walnut, etc. The top of the coffin has an elongated lid 12 at the foot of the coffin and a small lid 14 at the head of the coffin. The elongated lid 12 may be fixed to the body of the coffin or it may be attached with small hinges and held closed by means of a small catch (not shown) which may be a mechanical latch, a magnetic latch, a push to release type of latch or a spring loaded hinge designed to keep the cover of the coffin in an open or closed position. The small lid 14 is attached to the body of the coffin with a spring loaded hinge 16 and a touch catch (not shown) which is provided to keep the small lid closed until the lid is tapped or pushed by a person, at which time it springs open. The inside of the coffin may be one continuous compartment or two compartments with a dividing wall which is aligned with the edge of the elongated lid or positioned slightly back from the edge of the elongated lid.

Referring to FIG. 2, there is shown a plan view of the bottom of the coffin. Located within the bottom of the coffin is a speaker 18 which is coupled to a recorder (not shown), a reset button 20 which is used to over-ride a recorded message on the recorder and/or to allow a user to record his/her own message, and a compartment 22 for holding a replaceable battery.

A switch such as a light sensitive switch or a set of make-break contacts, which are operated when the small lid is opened, starts the recorder to play a first message when the small lid is opened. The recorder can have at least four pre-recorded messages where each message can be a five second message and, if not interrupted, will play in the order that they were recorded. The reset button 20 on the bottom of the coffin, when operated, over-rides the prerecorded messages and allows the user to prerecord his/her own message or messages on a sound card located in the bottom of the coffin.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A miniature coffin comprising:
a small lid and an elongated lid located on the top of the coffin;
a spring loaded hinge attached to the small lid to urge the small lid to open;
a touch latch attached to the small lid to keep the small lid closed until touched by a person;
a recorder located within the coffin; and
a switch coupled to the small lid and to the recorder to cause the recorder to play at least one prerecorded message when the small lid is opened.

2. The miniature coffin of claim 1 wherein the small lid is located at the head of the coffin and the elongated lid is located at the foot of the coffin.

3. The miniature coffin of claim 2 wherein the elongated lid is fixed to the body of the coffin.

4. The miniature coffin of claim 2 wherein the elongated lid is attached to the body of the coffin with small hinges.

5. The miniature coffin of claim 4 wherein the small hinges are adapted to keep the elongated lid in an open or closed position.

6. The miniature coffin of claim 4 wherein the elongated lid is held closed with a latch.

7. The miniature coffin of claim 6 wherein the latch is a mechanical latch, a magnetic latch, or a push to release type of latch.

8. The miniature coffin of claim 2 wherein the small lid is attached to the body of the coffin with a spring loaded hinge which is adapted to urge the small lid to its open position.

9. The miniature coffin of claim 8 wherein the small lid is coupled to the body of the coffin with a touch latch which keeps the small lid closed until the lid is tapped or pushed by a person, at which time the small lid springs open.

10. The miniature coffin of claim 2 wherein the inside of the coffin is one continuous compartment.

11. The miniature coffin of claim 2 wherein the inside of the coffin has two compartments formed with a dividing wall which is aligned with the edge of the elongated lid or positioned back from the edge of the elongated lid.

12. The miniature coffin of claim 2 wherein the coffin is made of a plastic, fiberglass, wood, or metal.

13. The miniature coffin of claim 12 wherein the coffin has a length of between five and nine inches, a width of between two and three inches, and a height of between one and two inches.

14. The miniature coffin of claim 2 wherein the coffin has a reset button which, when operated, allow a user to over-ride the prerecorded messages and personalize his/her own message to a loved one.

15. The miniature coffin of claim 14 wherein a speaker is located in the bottom of the coffin and a replaceable battery is located within the coffin.

16. The miniature coffin of claim 14 wherein a switch is coupled to the small lid to cause the recorder to play a first message when the small lid is opened.

17. The miniature coffin of claim 16 wherein the recorder has at least two prerecorded messages wherein each message may be a five second message, and wherein if not interrupted will play the messages in the order that they were recorded.
